(19) United States
(12) Patent Application Publication
(10) Pub. No.: US 2022/0415273 A1
(43) Pub. Date: Dec. 29, 2022

(54) SIMULTANEOUS EMISSION PIXEL COMPENSATION CIRCUIT AND DISPLAY PANEL

(71) Applicant: Shenzhen China Star Optoelectronics Semiconductor Display Technology Co., Ltd., Shenzhen (CN)

(72) Inventor: Jinxiang CHEN, Shenzhen (CN)

(73) Assignee: Shenzhen China Star Optoelectronics Semiconductor Display Technology Co., Ltd., Shenzhen (CN)

(21) Appl. No.: 16/766,749

(22) PCT Filed: Apr. 21, 2020
(86) PCT No.: PCT/CN2020/085885

§ 371 Date: May 26, 2020

(30) Foreign Application Priority Data
Apr. 8, 2020 (CN) 202010267454.0

(51) Int. Cl. G09G 3/36; G09G 3/34

(52) U.S. Cl. CPC G09G 3/3611; G09G 3/3406; G09G 2300/0819; G09G 2300/0852; G09G 2310/08; G09G 2320/0233; G09G 2300/0426

(57) ABSTRACT

The present application provides a simultaneous emission pixel compensation circuit and a display panel. Through adopting a transistor with a double-gate structure as a driving transistor, and through a bottom gate to regulate a threshold voltage of the driving transistor, compensation of positive and negative drift of the threshold voltage of the driving transistor is realized. Through introducing simultaneous emission technology and adopting a global signal to perform corresponding control, a number of a scan signal to scan row by row is decreased to only one, such that a circuit structure is simple and a number of transistors required is less, thereby facilitating integration in a panel.

### FIELD OF INVENTION

The present application relates to the field of display technology, and especially to a simultaneous emission pixel compensation circuit and a display panel.

### BACKGROUND OF INVENTION

In a pixel compensation circuit that adopts thin film transistors (TFTs), first, amorphous silicon (a-Si) TFT large-area production processes that are maturely developed have satisfactory uniformity, and are widely applied in TFT liquid crystal displays (LCDs). Second, low temperature polycrystalline silicon (LTPS) TFTs have high mobility and better stability, and are applicable to small and medium-sized panels. Third, oxide TFTs have higher mobility, satisfactory uniformity of large-area production, low manufacturing temperatures, satisfactory transparency, and high flexibility, and therefore can be applied to large-sized high definition displays.

### SUMMARY OF INVENTION

However, a-Si TFTs' mobility is low and hard to satisfy higher resolution requirements, LTPS TFTs' uniformity of large-area production is poor because of existence of a crystal boundary, and oxide TFTs' threshold voltage (Vth) has high drift value, which causes serious mura deficiencies of panels.

Therefore, it becomes a technical problem needed to be improved in development of conventional pixel compensation circuit technology how to resolve deficiencies of ununiform panel brightness due to difference in threshold voltages of driving TFTs caused by manufacturing processes, realize compensation of positive and negative drift of a threshold voltage, and decrease a number of a scan signal to scan row by row.

Embodiments of the present application provide a simultaneous emission pixel compensation circuit and a display panel to resolve difference in threshold voltages of driving TFTs, to realize compensation of positive and negative drift of a threshold voltage, to decrease a number of a scan signal to scan row by row, and to realize simultaneous emission.

Embodiments of the present application provides a simultaneous emission pixel compensation circuit that includes a plurality of pixel compensation units, wherein the pixel compensation units include: a reset signal response module configured to transmit an initialization voltage in response to a reset signal; a sensing signal response module configured to transmit the initialization voltage and a reference voltage in response to a sensing signal; a scan transistor configured to transmit a data voltage in response to a scan signal; a driving transistor adopting a double-gate metal-oxide-semiconductor field-effect transistor, wherein a bottom gate of the driving transistor is electrically connected to a first node to receive the reference voltage, a top gate thereof is electrically connected to a second node to receive the initialization voltage or the data voltage, a first electrode thereof is electrically connected to a driving voltage terminal, a second electrode thereof is electrically connected to a third node to receive the initialization voltage, and the driving transistor is configured to regulate a threshold voltage of the driving transistor through the bottom gate according to the initialization voltage and the reference voltage, and to generate driving current according to the data voltage; and a light-emitting device configured to emit light according to the driving current; wherein, in the circuit, the scan signal is a signal to scan row by row and configured to make the scan transistor of a corresponding pixel compensation unit conduct row by row in a time of a frame, and the reset signal and the sensing signal are a global signal and configured to correspondingly control all of the pixel compensation units in the time of the frame.

Embodiments of the present application further provides a simultaneous emission pixel compensation circuit that includes a plurality of pixel compensation units, wherein the pixel compensation units include: a reset signal response module configured to transmit an initialization voltage in response to a reset signal; a sensing signal response module configured to transmit the initialization voltage and a reference voltage in response to a sensing signal; a scan transistor configured to transmit a data voltage in response to a scan signal; a driving transistor adopting a double-gate structure, wherein the driving transistor is configured to regulate a threshold voltage of the driving transistor through the bottom gate according to the initialization voltage and the reference voltage, and to generate driving current according to the data voltage; and a light-emitting device configured to emit light according to the driving current.

Embodiments of the present application further provides a display panel that includes an array substrate, wherein the array substrate includes a simultaneous emission pixel compensation circuit according to the present application.

Through adopting a transistor with a double-gate structure as a driving transistor, and through a bottom gate to regulate a threshold voltage of the driving transistor, a pixel compensation circuit according to the present application realizes compensation of positive and negative drift of the threshold voltage of the driving transistor, resolves difference in threshold voltages of driving transistors, and increases uniformity of panel brightness. Through introducing simultaneous emission technology and adopting a global signal to perform corresponding control, a number of a scan signal to scan row by row is decreased to only one, such that a circuit structure is simple and a number of transistors required is less, thereby facilitating integration in a panel.

### DESCRIPTION OF DRAWINGS

The accompanying figures to be used in the description of embodiments of the present application or prior art will be described in brief to more clearly illustrate the technical solutions of the embodiments or the prior art. The accompanying figures described below are only part of the embodiments of the present application, from which figures those skilled in the art can derive further figures without making any inventive efforts.

FIG. 1 is a schematic diagram of a structure of a double-gate field-effect transistor and threshold voltage adjustment under different aspect ratios.

FIG. 2 is a schematic diagram of a simultaneous emission pixel compensation circuit according to the present application.

FIG. 3A is a circuit diagram of a simultaneous emission pixel compensation circuit according to a first embodiment of the present application.

FIG. 3B is a driving timing diagram of the pixel compensation circuit shown in FIG. 3A.

FIG. 4A is a circuit diagram of a simultaneous emission pixel compensation circuit according to a second embodiment of the present application.

FIG. 4B is a driving timing diagram of the pixel compensation circuit shown in FIG. 4A.

FIG. 5 is a schematic diagram of a display panel according to the present application.

### DETAILED DESCRIPTION OF PREFERRED EMBODIMENTS

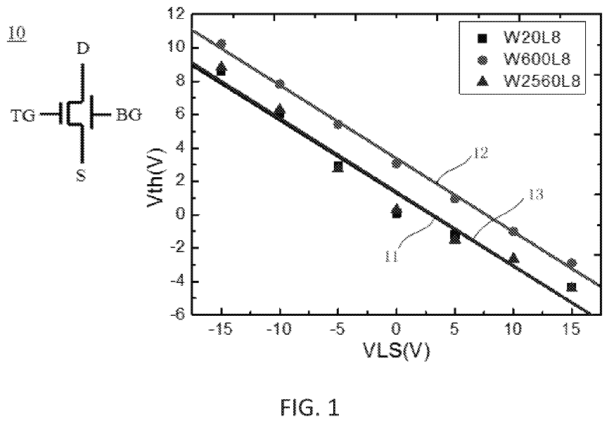

Referring to FIG. 1, FIG. 1 is a schematic diagram of a structure of a double-gate field-effect transistor and threshold voltage adjustment under different aspect ratios.

The double-gate field-effect transistor 10 is a double-gate metal-oxide-semiconductor field-effect transistor that includes a bottom gate BG, a top gate TG, a source S, and a drain D. Through adjusting the bottom gate BG of the double-gate metal-oxide-semiconductor field-effect transistor 10, its threshold voltage Vth can be adjusted. Specifically, the double-gate metal-oxide-semiconductor field-effect transistor 10 can be an indium tin zinc oxide thin film transistor (ITZO TFT).

Studies found that double-gate metal-oxide-semiconductor field-effect transistors with different aspect ratios have gamma reference voltage values (Gam) close to each other, and can realize adjustment of a threshold voltage Vth. For example, as shown in the figure, an aspect ratio W/L of a fitted line 11 is 20/8, and a fitting formula is y=1.29564−0.4376x. An aspect ratio W/L of a fitted line 12 is 600/8, and a fitting formula is y=3.37416−0.4393x. An aspect ratio W/L of a fitted line 13 is 2560/8, and a fitting formula is y=1.3688−0.4419x. It can be seen from the figure, double-gate metal-oxide-semiconductor field-effect transistors with different aspect ratios have Gam values close to each other. A threshold voltage Vth of a double-gate metal-oxide-semiconductor field-effect transistor can be adjusted through adjusting a bottom gate, and double-gate metal-oxide-semiconductor field-effect transistors with different aspect ratios can realize adjustment of the threshold voltage Vth, such kind of properties gives ability for double-gate metal-oxide-semiconductor field-effect transistors to flexibly realize conduction, and the present application uses this advantage to develop a new internal pixel compensation circuit.

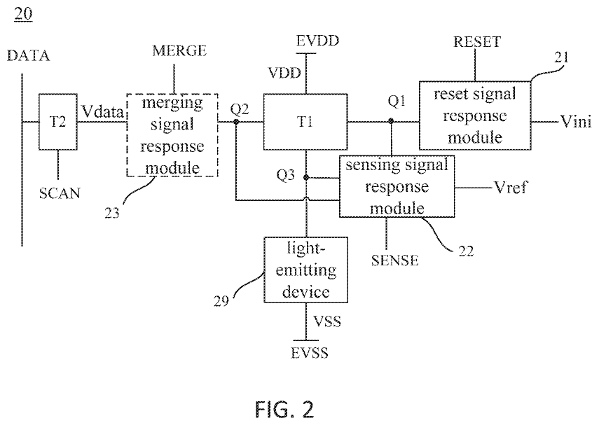

Referring to FIG. 2, FIG. 2 is a schematic diagram of a simultaneous emission pixel compensation circuit according to the present application. The pixel compensation circuit according to the present application includes a plurality of pixel compensation units 20, and the pixel compensation units 20 include: a reset signal response module 21, a sensing signal response module 22, a scan transistor T2, a driving transistor T1, and a light-emitting device 29.

The reset signal response module 21 is configured to transmit an initialization voltage Vini in response to a reset signal RESET, the sensing signal response module 22 is configured to transmit the initialization voltage Vini and a reference voltage Vref in response to a sensing signal SENSE, the scan transistor T2 is configured to transmit a data voltage Vdata in response to a scan signal SCAN, the driving transistor T1 adopts a double-gate structure, and is configured to regulate a threshold voltage Vth of the driving transistor T1 through a bottom gate according to the initialization voltage Vini and the reference voltage Vref, and to generate driving current according to the data voltage Vdata, and the light-emitting device 29 is configured to emit light according to the driving current.

Specifically, a bottom gate (BG) of the driving transistor T1 with the double-gate structure is electrically connected to a first node Q1, a top gate (TG) thereof is electrically connected to a second node Q2, a first electrode thereof is electrically connected to a driving voltage terminal EVDD to receive a driving voltage VDD, and a second electrode thereof is electrically connected to a third node Q3. A gate of the scan transistor T2 is configured to receive the scan signal SCAN, a first electrode thereof is electrically connected to a data signal line DATA to receive the data voltage Vdata, and a second electrode thereof is electrically connected to or coupled to the second node Q2. The light-emitting device 29 is electrically connected between the third node Q3 and a common voltage terminal EVSS. Advantageously, the driving transistor T1 adopts a double-gate metal-oxide-semiconductor field-effect transistor. The light-emitting device 29 adopts a light-emitting diode. Wherein, a driving voltage VDD output by the driving voltage terminal EVDD and a common voltage VSS output by the common voltage terminal EVSS are both an alternating voltage signal that can alternate between high and low electrical levels.

Specifically, the reset signal response module 21 is electrically connected to the third node Q3 to transmit the initialization voltage Vini to the third node Q3 in response to the reset signal RESET. The sensing signal response module 22 is electrically connected to the first node Q1, the second node Q2, and the third node Q3 to transmit the initialization voltage Vini of the third node Q3 to the second node Q2, and to transmit the reference voltage Vref to the first node Q1, in response to the sensing signal SENSE.

During a reset stage, the top gate and the second electrode of the driving transistor T1 are reset to the initialization voltage Vini (the driving transistor T1 is in a diode-connect manner), the bottom gate thereof is written in the reference voltage Vref. Wherein, a voltage value of the reference voltage Vref is greater than that of the initialization voltage Vini such that the reference voltage Vref and the initialization voltage Vini make a threshold voltage Vth of the driving transistor T1 be adjusted as a negative value. The common voltage terminal EVSS outputs a high electrical level common voltage VSS, and the light-emitting diode does not emit light.

During a compensation stage, the reset signal response module 21 no longer transmits the initialization voltage Vini, and the driving voltage terminal EVDD provides the driving voltage VDD for the second electrode of the driving transistor T1 to make its electrical potential incessantly increase such that a voltage difference Vbs between the bottom gate and the second electrode incessantly decreases. According to principles of threshold voltage Vth adjustment of a bottom gate, it can be seen that the threshold voltage Vth of the driving transistor T1 becomes zero from a negative value gradually, and finally makes the driving transistor T1 cut off. At this time, the threshold voltage Vth is equal to a voltage difference Vgs between the top gate and the second electrode, that is, Vth=Vgs. Because Vgs of a driving transistor in a pixel compensation unit each pixel corresponds is zero volt, each corresponding threshold voltage Vth is constantly zero, which realizes a function to globally adjust a threshold voltage Vth in a panel to be equal, and realizes a goal of increasing brightness uniformity of the panel.

In further embodiments, in the circuit, the scan signal SCAN is a signal to scan row by row configured to conduct the scan transistor T2 of a corresponding pixel compensation unit row by row in a time of a frame, and the reset signal RESET and the sensing signal SENSE are a global signal configured to correspondingly control all of the pixel compensation units 20 in the time of the frame.

In a light-emitting stage of the time of the frame, first performing compensational writing of the data voltage Vdata, and then realizing light emitting through a time sequence design, to spare 21% of a duty cycle for writing of the data voltage Vdata and realize a light-emitting time of 79% of the duty cycle, that is, a proportion of the light-emitting time of the light-emitting device 29 is substantially 79%. In the time of the frame, the reset signal RESET and the sensing signal SENSE correspondingly control all of the pixel compensation units 20, that is, specifically, controlling corresponding transistors to simultaneously conduct or turn off, and the scan signal SCAN scans and conducts a corresponding scan transistor T2 row by row. The pixel compensation circuit according to the present application can realize simultaneous emission, and decrease a number of a scan signal to scan row by row, wherein each pixel compensation unit includes only one scan signal.

In further embodiments, the pixel compensation unit 20 further includes a merging signal response module 23 (dotted box means an optional component). The merging signal response module 23 is configured to store and transmit the data voltage Vdata in response to a merging signal MERGE. Specifically, the data voltage Vdata of a previous frame is stored in the merging signal response module 23 in a light-emitting stage of a present frame such that a light-emitting time of almost 100% of a duty cycle in the light-emitting stage of the time of the frame is realized. Specifically, in the circuit, the merging signal MERGE is also a global signal configured to correspondingly control all of the pixel compensation units in the time of the frame, specifically, controlling corresponding transistors to simultaneously conduct or turn off.

Through adopting a transistor with a double-gate structure as a driving transistor, and through a bottom gate to regulate a threshold voltage of the driving transistor, a pixel compensation circuit according to the present application realizes compensation of positive and negative drift of the threshold voltage of the driving transistor, resolves difference in threshold voltages of driving transistors, and increases uniformity of panel brightness. Through introducing simultaneous emission technology and adopting a global signal to perform corresponding control, a number of a scan signal to scan row by row is decreased to only one, such that a circuit structure is simple and a number of transistors required is less, thereby facilitating integration in a panel.

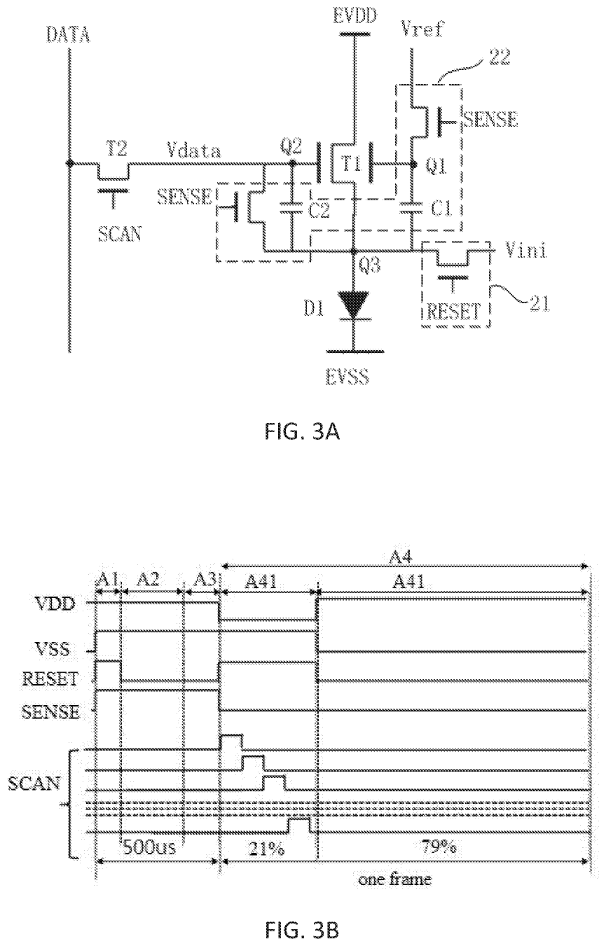

Refer to FIG. 2, and also refer to FIG. 3A and FIG. 3B. Wherein, FIG. 3A is a circuit diagram of a simultaneous emission pixel compensation circuit according to a first embodiment of the present application, and FIG. 3B is a driving timing diagram of the pixel compensation circuit shown in FIG. 3A.

As shown in FIG. 3A, in the present embodiment, a pixel compensation unit of the pixel compensation circuit adopts a 5T2C structure, in which thin film transistors (TFTs) are n-channel TFTs (NTFTs), a drain of the NTFTs is a first electrode of a corresponding transistor, and a source of the NTFTs is a second electrode of a corresponding transistor. A TFT structure and a circuit realization method according to the present application have universality. Wherein, the scan signal SCAN is a signal to scan row by row, and conducts a gate terminal of a corresponding scan transistor T2 row by row in a time of a frame. The reset signal RESET and the sensing signal SENSE are a global signal, and control a corresponding transistor in all of the pixel compensation units of the pixel compensation circuit to simultaneously conduct or turn off in the time of the frame.

Specifically, the driving transistor T1 adopts a double-gate metal-oxide-semiconductor field-effect transistor. A bottom gate of the driving transistor T1 is electrically connected to a first node Q1, a top gate thereof is electrically connected to a second node Q2, a first electrode thereof is electrically connected to a driving voltage terminal EVDD to receive a driving voltage VDD, and a second electrode thereof is electrically connected to a third node Q3.

Specifically, a gate of the scan transistor T2 is configured to receive a scan signal SCAN, a first electrode thereof is electrically connected to a data signal line DATA to receive a data voltage Vdata, and a second electrode thereof is electrically connected to the second node Q2.

Specifically, the light-emitting device 29 adopts a light-emitting diode D1. An anode of the light-emitting diode D1 is electrically connected to the third node Q3, and a cathode thereof is electrically connected to a common voltage terminal EVSS.

Specifically, the reset signal response module 21 includes a reset transistor TR, a gate of the reset transistor TR is configured to receive a reset signal RESET, a first electrode thereof is configured to receive an initialization voltage Vini, and a second electrode thereof is electrically connected to the third node Q3. The reset transistor TR is configured to conduct in response to the reset signal RESET and transmit the initialization voltage Vini to the third node Q3.

Specifically, the sensing signal response module 22 includes a first sensing transistor TS1, a second sensing transistor TS2, a first capacitor C1, and a second capacitor C2. A gate of the first sensing transistor TS1 is configured to receive a sensing signal SENSE, a first electrode thereof is configured to receive a reference voltage Vref, and a second electrode thereof is electrically connected to the first node Q1. The first sensing transistor TS1 is configured to conduct in response to the sensing signal SENSE and transmit the reference voltage Vref to the first node Q1. A gate of the second sensing transistor TS2 is configured to receive the sensing signal SENSE, a first electrode thereof is electrically connected to the third node Q3, and a second electrode thereof is electrically connected to the second node Q2. The second sensing transistor TS2 is configured to conduct in response to the sensing signal SENSE and transmit the initialization voltage Vini of the third node Q3 to the second node Q2. The first capacitor C1 is electrically connected between the first node Q1 and the third node Q3 and configured to store a voltage difference Vbs between the bottom gate of the driving transistor T1 and the second electrode of the driving transistor T1. The second capacitor C2 is electrically connected between the second node Q2 and the third node Q3 and configured to store a voltage difference Vgs between the top gate of the driving transistor T1 and the second electrode of the driving transistor T1.

As shown in FIG. 3B, a time of a frame is divided into a reset stage, a compensation stage, a data writing stage, and a light-emitting stage. During the reset stage, the written reference voltage Vref and the initialization voltage Vini make a threshold voltage Vth of the driving transistor T1 negative. In the light-emitting stage of the time of the frame, first performing compensational writing of the data voltage Vdata, and then realizing light emitting through a time sequence design, to spare 21% of a duty cycle for writing of the data voltage Vdata and realize a light-emitting time of 79% of the duty cycle. In the time of the frame, the reset signal RESET and the sensing signal SENSE control corresponding transistors to simultaneously conduct or turn off, and the scan signal SCAN scans and conducts a corresponding scan transistor T2 row by row. The pixel compensation circuit according to the present application can realize simultaneous emission, and decrease a number of a scan signal to scan row by row, wherein each pixel compensation unit includes only one scan signal.

The following gives further description of an operating principle of a simultaneous emission pixel compensation circuit according to the present application with reference to FIG. 3A and FIG. 3B. A specific operating principle is as the following.

Reset stage A1: the reset signal RESET is at a high electrical level, the reset transistor TR conducts, and the third node Q3 is written in an initialization voltage Vini signal to refresh a previous frame's signal. The sensing signal SENSE is at a high electrical level, the first sensing transistor TS1 conducts, and the first node Q1 is written in a reference voltage Vref signal. The second sensing transistor TS2 conducts such that the top gate of the driving transistor T1 is connected to the second electrode (source) to form a diode-connect manner, and the top gate and the source of the driving transistor T1 are written in the initialization voltage Vini signal. The common voltage VSS output by the common voltage terminal EVSS is switched into a high electrical level, and the light-emitting diode D1 reversely cuts off and does not emit light. Because the reference voltage Vref is greater than the initialization voltage Vini, at this time, a threshold voltage Vth of the driving transistor T1 is negative.

Compensation stage A2: the reset signal RESET alternates into a low electrical level, and the reset transistor TR is turned off. The driving voltage VDD output by the driving voltage terminal EVDD is at a high electrical level, and the driving voltage VDD charges the source of the driving transistor T1 such that electrical potential of the source incessantly increases and a voltage difference Vbs between the bottom gate of the driving transistor T1 and the source incessantly decreases.

Data writing stage A3: a time sequence of each of the signals remains unchanged. According to principles of threshold voltage Vth adjustment of a bottom gate, it can be seen that the threshold voltage Vth of the driving transistor T1 becomes zero from a negative value gradually, and finally makes the driving transistor T1 cut off. At this time, Vth=Vgs. When the driving transistor T1 is cut off, the first sensing transistor TS1 and the second sensing transistor TS2 are turned off, and the first capacitor C1 records voltage of Vbs at this time, while the second capacitor C2 stores voltage of Vgs. Because Vgs of a driving transistor in a pixel compensation unit each pixel corresponds is zero volt, each corresponding threshold voltage Vth is constantly zero, which realizes a function to globally adjust a threshold voltage Vth in a panel to be equal, and realizes a goal of increasing brightness uniformity of the panel.

The light-emitting stage A4 includes a first light-emitting stage A41 and a second light-emitting stage A42. During the first light-emitting stage A41, the driving voltage VDD alternates into a low electrical level, the reset signal RESET alternates into a high electrical level, and the sensing signal SENSE alternates into a low electrical level. The data voltage Vdata is written into the top gate of the driving transistor T1, and the scan signal SCAN scans and conducts a corresponding scan transistor T2 row by row. During the second light-emitting stage A42, the driving voltage VDD alternates into a high electrical level, the common voltage Vss alternates into a low electrical level, and the reset signal RESET alternates into a low electrical level. The driving transistor T1 generates driving current, and the light-emitting diode D1 emits light. That is, in the light-emitting stage A4 of the time of the frame, first performing compensational writing of the data voltage Vdata, and then realizing light emitting through a time sequence design, to spare 21% of a duty cycle for writing of the data voltage Vdata (the first light-emitting stage A41) and realize a light-emitting time of 79% of the duty cycle (the second light-emitting stage A42), that is, a proportion of the light-emitting time of the light-emitting device 29 is substantially 79%.

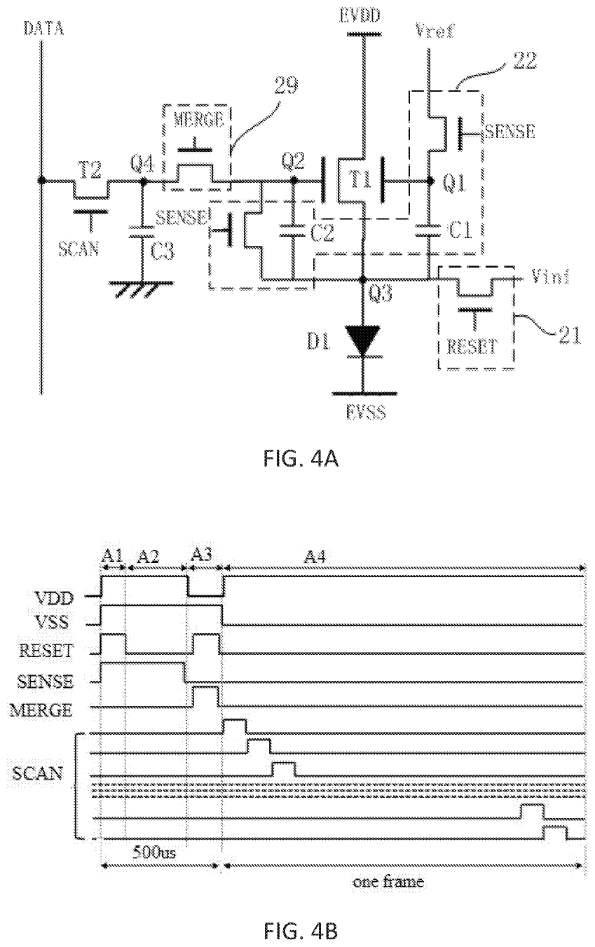

Refer to FIG. 2, and also refer to FIG. 4A and FIG. 4B. Wherein, FIG. 4A is a circuit diagram of a simultaneous emission pixel compensation circuit according to a second embodiment of the present application, and FIG. 4B is a driving timing diagram of the pixel compensation circuit shown in FIG. 4A.

As shown in FIG. 4A, in the present embodiment, a pixel compensation unit of the pixel compensation circuit adopts a 6T3C structure, in which thin film transistors (TFTs) are n-channel TFTs (NTFTs), a drain of the NTFTs is a first electrode of a corresponding transistor, and a source of the NTFTs is a second electrode of a corresponding transistor. A TFT structure and a circuit realization method according to the present application have universality. Wherein, the scan signal SCAN is a signal to scan row by row, and conducts a gate terminal of a corresponding scan transistor T2 row by row in a time of a frame. The reset signal RESET, the sensing signal SENSE, and the merging signal MERGE are a global signal, and control a corresponding transistor in all of the pixel compensation units of the pixel compensation circuit to simultaneously conduct or turn off in the time of the frame.

Specifically, the driving transistor T1 adopts a double-gate metal-oxide-semiconductor field-effect transistor. A bottom gate of the driving transistor T1 is electrically connected to a first node Q1, a top gate thereof is electrically connected to a second node Q2, a first electrode thereof is electrically connected to a driving voltage terminal EVDD to receive a driving voltage VDD, and a second electrode thereof is electrically connected to a third node Q3.

Specifically, a gate of the scan transistor T2 is configured to receive a scan signal SCAN, a first electrode thereof is electrically connected to a data signal line DATA to receive a data voltage Vdata, and a second electrode thereof is electrically connected to a fourth node Q4.

Specifically, the light-emitting device 29 adopts a light-emitting diode D1. An anode of the light-emitting diode D1 is electrically connected to the third node Q3, and a cathode thereof is electrically connected to a common voltage terminal EVSS.

Specifically, the reset signal response module 21 includes a reset transistor TR, a gate of the reset transistor TR is configured to receive a reset signal RESET, a first electrode thereof is configured to receive an initialization voltage Vini, and a second electrode thereof is electrically connected to the third node Q3. The reset transistor TR is configured to conduct in response to the reset signal RESET and transmit the initialization voltage Vini to the third node Q3.

Specifically, the sensing signal response module 22 includes a first sensing transistor TS1, a second sensing transistor TS2, a first capacitor C1, and a second capacitor C2. A gate of the first sensing transistor TS1 is configured to receive a sensing signal SENSE, a first electrode thereof is configured to receive a reference voltage Vref, and a second electrode thereof is electrically connected to the first node Q1. The first sensing transistor TS1 is configured to conduct in response to the sensing signal SENSE and transmit the reference voltage Vref to the first node Q1. A gate of the second sensing transistor TS2 is configured to receive the sensing signal SENSE, a first electrode thereof is electrically connected to the third node Q3, and a second electrode thereof is electrically connected to the second node Q2. The second sensing transistor TS2 is configured to conduct in response to the sensing signal SENSE and transmit the initialization voltage Vini of the third node Q3 to the second node Q2. The first capacitor C1 is electrically connected between the first node Q1 and the third node Q3 and configured to store a voltage difference Vbs between the bottom gate of the driving transistor T1 and the second electrode of the driving transistor T1. The second capacitor C2 is electrically connected between the second node Q2 and the third node Q3 and configured to store a voltage difference Vgs between the top gate of the driving transistor T1 and the second electrode of the driving transistor T1.

Specifically, the merging signal response module 23 includes a merging transistor TM and a third capacitor C3. A gate of the merging transistor TM is configured to receive the merging signal MERGE, a first electrode thereof is electrically connected to the fourth node Q4 (that is, input by the scan transistor T2) and configured to receive the data voltage Vdata transmitted by the scan transistor T2, and a second electrode thereof is electrically connected to the second node Q2 (the top gate of the driving transistor T1). The merging transistor TM is configured to conduct and transmit the data voltage Vdata of the fourth node Q4 to the second node Q2 in response to the merging signal MERGE. A first electrode plate of the third capacitor C3 is electrically connected to the fourth node Q4 and configured to receive the data voltage Vdata, and a second electrode plate thereof is electrically connected to a common ground terminal and configured to store the data voltage Vdata.

As shown in FIG. 4B, a time of a frame is divided into a reset stage, a compensation stage, a data writing stage, and a light-emitting stage. During the reset stage, the written reference voltage Vref and the initialization voltage Vini make a threshold voltage Vth of the driving transistor T1 negative. In the light-emitting stage of the time of the frame, because the data voltage Vdata of a previous frame is stored in the third capacitor C3 of the merging signal response module 23 during the light-emitting stage of the present frame, a light-emitting time of almost 100% of a duty cycle is realized. In the time of the frame, the reset signal RESET, the sensing signal SENSE, and the merging signal MERGE control corresponding transistors to simultaneously conduct or turn off, and the scan signal SCAN scans and conducts a corresponding scan transistor T2 row by row. The pixel compensation circuit according to the present application can realize simultaneous emission, and decrease a number of scan transistors to scan row by row, wherein each pixel compensation unit adopts only one scan transistor.

The following gives further description of an operating principle of a simultaneous emission pixel compensation circuit according to the present application with reference to FIG. 4A and FIG. 4B. A specific operating principle is as the following.

Reset stage A1: the reset signal RESET is at a high electrical level, the reset transistor TR conducts, and the third node Q3 is written in an initialization voltage Vini signal to refresh a previous frame's signal. The sensing signal SENSE is at a high electrical level, the first sensing transistor TS1 conducts, and the first node Q1 is written in a reference voltage Vref signal. The second sensing transistor TS2 conducts such that the top gate of the driving transistor T1 is connected to the second electrode (source) to form a diode-connect manner, and the top gate and the source of the driving transistor T1 are written in the initialization voltage Vini signal. The common voltage VSS output by the common voltage terminal EVSS is switched into a high electrical level, and the light-emitting diode D1 reversely cuts off and does not emit light. Because the reference voltage Vref is greater than the initialization voltage Vini, at this time, a threshold voltage Vth of the driving transistor T1 is negative.

Compensation stage A2: the reset signal RESET alternates into a low electrical level, and the reset transistor TR is turned off. The driving voltage VDD output by the driving voltage terminal EVDD is at a high electrical level, and the driving voltage VDD charges the source of the driving transistor T1 such that electrical potential of the source incessantly increases and a voltage difference Vbs between the bottom gate of the driving transistor T1 and the source incessantly decreases. According to principles of threshold voltage Vth adjustment of a bottom gate, it can be seen that the threshold voltage Vth of the driving transistor T1 becomes zero from a negative value gradually, and finally makes the driving transistor T1 cut off. At this time, Vth=Vgs. When the driving transistor T1 is cut off, the first sensing transistor TS1 and the second sensing transistor TS2 are turned off, and the first capacitor C1 records voltage of Vbs at this time, while the second capacitor C2 stores voltage of Vgs. Because Vgs of a driving transistor in a pixel compensation unit each pixel corresponds is zero volt, each corresponding threshold voltage Vth is constantly zero, which realizes a function to globally adjust a threshold voltage Vth in a panel to be equal, and realizes a goal of increasing brightness uniformity of the panel.

Data writing stage A3: the driving voltage VDD alternates into a low electrical level, the reset signal RESET alternates into a high electrical level, the sensing signal SENSE alternates into a low electrical level, and the merging signal MERGE alternates into a high electrical level. The merging transistor TM conducts, and the data voltage Vdata of a previous frame stored in the third capacitor C3 is written into the top gate of the driving transistor.

Light-emitting stage A4: the driving voltage VDD alternates into a high electrical level, the common voltage VSS alternates into a low electrical level, the reset signal RESET alternates into a low electrical level, and the merging signal MERGE alternates into a low electrical level. The scan signal SCAN scans and conducts a corresponding scan transistor T2 row by row. The driving transistor T1 generates driving current, and the light-emitting diode D1 emits light. That is, in the light-emitting stage A4 of the time of the frame, a light-emitting time of 100% of a duty cycle is realized, that is, a proportion of the light-emitting time of the light-emitting device 29 is substantially 100%.

Based on a same invention thought, the present application further provides a display panel.

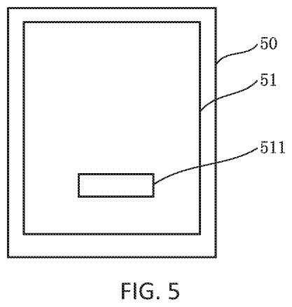

Referring to FIG. 5, FIG. 5 is a schematic diagram of a display panel according to the present application. The display panel 50 includes an array substrate 51, and the array substrate 51 includes a pixel compensation circuit 511. The pixel compensation circuit 511 adopts any one of simultaneous emission pixel compensation circuits of FIG. 2, FIG. 3A, and FIG. 4A of the present application. A component connection method and operating principle of the pixel compensation circuit 511 have previously been described in detail and repeated description is omitted here.

Through a bottom gate to regulate a threshold voltage of a driving transistor adopting a double-gate structure, a display panel adopting a simultaneous emission pixel compensation circuit according to the present application realizes compensation of positive and negative drift of the threshold voltage of the driving transistor, resolves difference in threshold voltages of driving transistors, and increases uniformity of panel brightness. Through introducing simultaneous emission technology and adopting a global signal to perform corresponding control, a number of a scan signal to scan row by row is decreased to only one, such that a circuit structure is simple and a number of transistors required is less, thereby facilitating integration in a panel.

It can be understood that it is obvious to those skilled in the art having regard to this present application that other modifications of the exemplary embodiments beyond these embodiments specifically described here may be made without departing from the spirit of the application. Such modifications are considered within the scope of the application as limited solely by the appended claims.

What is claimed is:

1. A simultaneous emission pixel compensation circuit, comprising a plurality of pixel compensation units, wherein the pixel compensation units comprise:
a reset signal response module configured to transmit an initialization voltage in response to a reset signal;
a sensing signal response module configured to transmit the initialization voltage and a reference voltage in response to a sensing signal;
a scan transistor configured to transmit a data voltage in response to a scan signal;
a driving transistor adopting a double-gate metal-oxide-semiconductor field-effect transistor, wherein a bottom gate of the driving transistor is electrically connected to a first node to receive the reference voltage, a top gate thereof is electrically connected to a second node to receive the initialization voltage or the data voltage, a first electrode thereof is electrically connected to a driving voltage terminal, a second electrode thereof is electrically connected to a third node to receive the initialization voltage, and the driving transistor is configured to regulate a threshold voltage of the driving transistor through the bottom gate according to the initialization voltage and the reference voltage, and to generate driving current according to the data voltage; and
a light-emitting device configured to emit light according to the driving current;
wherein, in the circuit, the scan signal is a signal to scan row by row and configured to make the scan transistor of a corresponding pixel compensation unit conduct row by row in a time of a frame, and the reset signal and the sensing signal are a global signal and configured to correspondingly control all of the pixel compensation units in the time of the frame.

2. The simultaneous emission pixel compensation circuit as claimed in claim 1, wherein in a light-emitting stage of the time of the frame, a proportion of a light-emitting time of the light-emitting device is substantially 79%.

3. The simultaneous emission pixel compensation circuit as claimed in claim 1, wherein,
a gate of the scan transistor is configured to receive the scan signal, a first electrode thereof is configured to receive the data voltage, and a second electrode thereof is electrically connected or coupled to the second node; and
the light-emitting device is electrically connected between the third node and a common voltage terminal.

4. The simultaneous emission pixel compensation circuit as claimed in claim 1, wherein the reset signal response module comprises a reset transistor, a gate of the reset transistor is configured to receive the reset signal, a first electrode thereof is configured to receive the initialization voltage, and a second electrode thereof is electrically connected to the third node.

5. The simultaneous emission pixel compensation circuit as claimed in claim 1, wherein the sensing signal response module comprises:
a first sensing transistor, wherein a gate of the first sensing transistor is configured to receive the sensing signal, a first electrode thereof is configured to receive the reference voltage, and a second electrode thereof is electrically connected to the first node;
a second sensing transistor, wherein a gate of the second sensing transistor is configured to receive the sensing signal, a first electrode thereof is electrically connected to the third node, and a second electrode thereof is electrically connected to the second node;
a first capacitor electrically connected between the first node and the third node and configured to store a voltage difference between the bottom gate of the driving transistor and the second electrode of the driving transistor; and
a second capacitor electrically connected between the second node and the third node and configured to store a voltage difference between the top gate of the driving transistor and the second electrode of the driving transistor.

6. The simultaneous emission pixel compensation circuit as claimed in claim 1, wherein the pixel compensation units further comprise a merging signal response module, and the merging signal response module is configured to store and transmit the data voltage in response to a merging signal.

7. The simultaneous emission pixel compensation circuit as claimed in claim 6, wherein in the circuit, the merging signal is the global signal and configured to correspondingly control all of the pixel compensation units in the time of the frame, and in a light-emitting stage of the time of the frame, a proportion of a light-emitting time of the light-emitting device is substantially 100%.

8. The simultaneous emission pixel compensation circuit as claimed in claim 6, wherein the merging signal response module comprises:
a merging transistor, wherein a gate of the merging transistor is configured to receive the merging signal, a first electrode thereof is input by the scan transistor and configured to receive the data voltage, and a second electrode thereof is electrically connected to the top gate of the driving transistor; and
a third capacitor, wherein a first electrode plate of the third capacitor is configured to receive the data voltage, and a second electrode plate thereof is electrically connected to a common ground terminal and configured to store the data voltage.

9. A simultaneous emission pixel compensation circuit, comprising a plurality of pixel compensation units, wherein the pixel compensation units comprise:
a reset signal response module configured to transmit an initialization voltage in response to a reset signal;
a sensing signal response module configured to transmit the initialization voltage and a reference voltage in response to a sensing signal;
a scan transistor configured to transmit a data voltage in response to a scan signal;
a driving transistor adopting a double-gate structure, wherein the driving transistor is configured to regulate a threshold voltage of the driving transistor through a bottom gate according to the initialization voltage and the reference voltage, and to generate driving current according to the data voltage; and
a light-emitting device configured to emit light according to the driving current.

10. The simultaneous emission pixel compensation circuit as claimed in claim 9, wherein in the circuit, the scan signal is a signal to scan row by row and configured to make the scan transistor of a corresponding pixel compensation unit conduct row by row in a time of a frame, and the reset signal and the sensing signal are a global signal and configured to correspondingly control all of the pixel compensation units in the time of the frame.

11. The simultaneous emission pixel compensation circuit as claimed in claim 10, wherein in a light-emitting stage of the time of the frame, a proportion of a light-emitting time of the light-emitting device is substantially 79%.

12. The simultaneous emission pixel compensation circuit as claimed in claim 9, wherein the driving transistor is a double-gate metal-oxide-semiconductor field-effect transistor.

13. The simultaneous emission pixel compensation circuit as claimed in claim 9, wherein,
the bottom gate of the driving transistor is electrically connected to a first node to receive the reference voltage, a top gate thereof is electrically connected to a second node to receive the initialization voltage or the data voltage, a first electrode thereof is electrically connected to a driving voltage terminal, and a second electrode thereof is electrically connected to a third node to receive the initialization voltage;
a gate of the scan transistor is configured to receive the scan signal, a first electrode thereof is configured to receive the data voltage, and a second electrode thereof is electrically connected or coupled to the second node; and
the light-emitting device is electrically connected between the third node and a common voltage terminal.

14. The simultaneous emission pixel compensation circuit as claimed in claim 13, wherein the reset signal response module comprises a reset transistor, a gate of the reset transistor is configured to receive the reset signal, a first electrode thereof is configured to receive the initialization voltage, and a second electrode thereof is electrically connected to the third node.

15. The simultaneous emission pixel compensation circuit as claimed in claim 13, wherein the sensing signal response module comprises:
a first sensing transistor, wherein a gate of the first sensing transistor is configured to receive the sensing signal, a first electrode thereof is configured to receive the reference voltage, and a second electrode thereof is electrically connected to the first node;
a second sensing transistor, wherein a gate of the second sensing transistor is configured to receive the sensing signal, a first electrode thereof is electrically connected to the third node, and a second electrode thereof is electrically connected to the second node;
a first capacitor electrically connected between the first node and the third node and configured to store a voltage difference between the bottom gate of the driving transistor and the second electrode of the driving transistor; and
a second capacitor electrically connected between the second node and the third node and configured to store a voltage difference between the top gate of the driving transistor and the second electrode of the driving transistor.

16. The simultaneous emission pixel compensation circuit as claimed in claim 9, wherein the pixel compensation units further comprise a merging signal response module, and the merging signal response module is configured to store and transmit the data voltage in response to a merging signal.

17. The simultaneous emission pixel compensation circuit as claimed in claim 16, wherein in the circuit, the scan signal is a signal to scan row by row and configured to make the scan transistor of a corresponding pixel compensation unit conduct row by row in a time of a frame, and the reset signal, the sensing signal, and the merging signal are a global signal and configured to correspondingly control all of the pixel compensation units in the time of the frame.

18. The simultaneous emission pixel compensation circuit as claimed in claim 17, wherein in a light-emitting stage of the time of the frame, a proportion of a light-emitting time of the light-emitting device is substantially 100%.

19. The simultaneous emission pixel compensation circuit as claimed in claim 16, wherein the merging signal response module comprises:
a merging transistor, wherein a gate of the merging transistor is configured to receive the merging signal, a first electrode thereof is input by the scan transistor and configured to receive the data voltage, and a second electrode thereof is electrically connected to the top gate of the driving transistor; and
a third capacitor, wherein a first electrode plate of the third capacitor is configured to receive the data voltage, and a second electrode plate thereof is electrically connected to a common ground terminal and configured to store the data voltage.

20. A display panel, comprising an array substrate, wherein the array substrate comprises a simultaneous emission pixel compensation circuit comprising a plurality of pixel compensation units, and the pixel compensation units comprise:
a reset signal response module configured to transmit an initialization voltage in response to a reset signal;
a sensing signal response module configured to transmit the initialization voltage and a reference voltage in response to a sensing signal;
a scan transistor configured to transmit a data voltage in response to a scan signal;
a driving transistor adopting a double-gate structure, wherein the driving transistor is configured to regulate a threshold voltage of the driving transistor through a bottom gate according to the initialization voltage and the reference voltage, and to generate driving current according to the data voltage; and
a light-emitting device configured to emit light according to the driving current.
